(19) United States
(12) Patent Application Publication
(10) Pub. No.: US 2018/0140501 A1
(43) Pub. Date: May 24, 2018

(54) Tongue sheath/sleeve/covering with an extension for adult sexual stimulation

(71) Applicants: Celia Ann Menezes, Loretto (CA); Julene Saunders, Toronto (CA)

(72) Inventors: Celia Ann Menezes, Loretto (CA); Julene Saunders, Toronto (CA)

(73) Assignees: Celia Menezes, Loretto (CA); Julene Saunders, Toronto (CA)

(21) Appl. No.: 15/358,105

(22) Filed: Nov. 21, 2016

(51) Int. Cl. A61H 19/00; A61H 7/00

(52) U.S. Cl. CPC A61H 19/00; A61H 19/30; A61H 2201/1253; A61H 7/002; A61H 2201/1695; A61H 19/40

(57) ABSTRACT

A tongue sheath/sleeve/covering with an extension for adult sexual stimulation.

This invention is an adult sex toy with a tongue sleeve or cover with an extension and protruding tip. The tongue sleeve or cover has little bumps that are raised to help with sensation. The tongue sleeve or cover has the same look front and back. It fits over the tongue and is mouldable. The tongue sleeve is secured to the tongue by pinching the sides in other words by moulding it to the tongue. The tongue sleeve has an extension with protruding tip and all parts are connected and flow as one. Therefore, the parts cannot be separated since they are attached.

The sex toy is made from silicone, but just as flexible and soft as a typical pacifier. The tongue sleeve is approximately 1.5 inches with raised bumps approximately 0.5 cm. The extension that is attached to the sleeve and is approximately 2.2×2 inches.

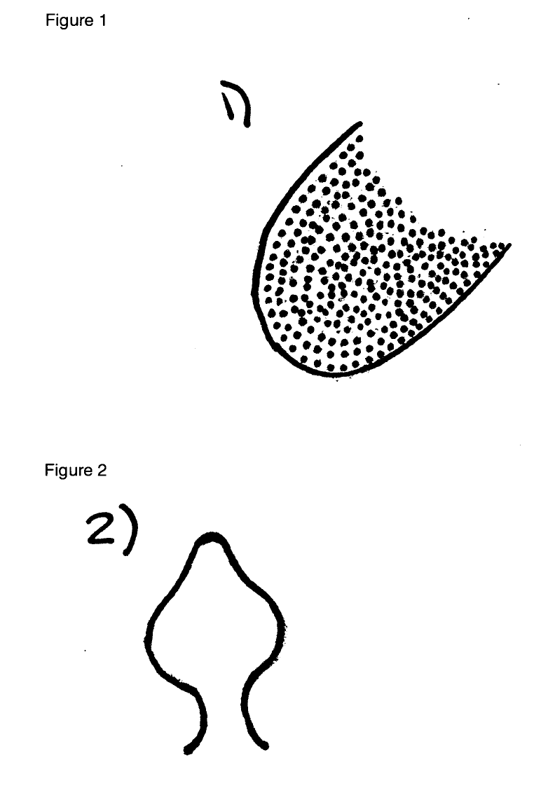

FIG. 1:

The tongue sleeve length is approximately 1.5 inches and is covered with tiny bumps. The raised bumps will be approximately 0.5 cm long and 0.5 cm wide.

The side(s) of the tongue will be mouldable in the sense that the consumers are able to squeeze or pinch the side(s) to mold and fit their tongue size. For example, it would feel similar to play dough.

FIG. 2:

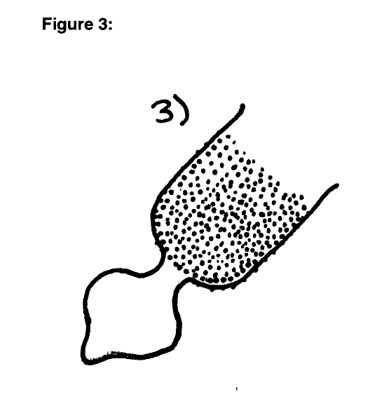

The attachment for the tongue sleeve FIG. 1. This ball like or pacifier type object will be attached to/extended from FIG. 1 outside of the mouth—length is approximately 2.2 inches and the width is 2 inches. The width increases gradually to approximately 2 inches and the length is approximately 2.2 inches including the tip in FIG. 3.

FIG. 3:

FIG. 3 is the sleeve—which is 1.5 inches and covered with tiny bumps-, the attachment—which is approximately 2.2 inches-, and the tip attached together. The sleeve fits over the tongue and the attachment which is the pacifier type object has tip or protruding end. The tongue sleeve is attached to the attachment with protruding tip. The attachment begins at the end of the tongue sleeve and extends outside the mouth. The sleeve with attachment has a tip for added pleasure.

1: A sex toy that is a tongue sleeve/cover with raised bumps for adult sexual stimulation.

2: A sex toy as in claim 1, wherein an extension or attachment is connected to the tongue sleeve.

3: A sex toy as in claim 1, wherein the extension has a protruding tip.

4: A sex toy as in claim 1, where the tongue sleeve with extension and protruding tip is made from silicone, which is considered to be a safer material.

5: A sex toy as in claim 1, wherein the tongue sleeve with extension and tip is mouldable.
